(19) United States
(12) Patent Application Publication
(10) Pub. No.: US 2024/0369057 A1
(43) Pub. Date: Nov. 7, 2024

(54) CYLINDER DEVICE FOR LINEAR COMPRESSOR INSTALLED WITH LINEAR PISTON

(71) Applicant: SCS CO., LTD., Sejong-si (KR)

(72) Inventor: Hyeong-Kyu JIN, Sejong-si (KR)

(73) Assignee: SCS CO., LTD., Sejong-si (KR)

(21) Appl. No.: 18/778,158

(22) Filed: Jul. 19, 2024

Related U.S. Application Data
(63) Continuation of application No. PCT/KR2023/000470, filed on Jan. 11, 2023.

(30) Foreign Application Priority Data
Jan. 19, 2022 (KR) 10-2022-0007555

(51) Int. Cl. F04B 53/16; F04B 27/08

(52) U.S. Cl. CPC F04B 53/162; F04B 27/0891

(57) ABSTRACT

The present invention relates to a cylinder device for a linear compressor installed with a linear piston, and more specifically, to a cylinder device in which a linear piston has compression sections formed at both ends centered on a driving section, the compression section having a larger circumference than that of the driving section, a Teflon material is applied to an outer surface of the compression section to act as a friction lubricant between the outer surface and an inner periphery of a piston hole, and a refrigerant can be sucked or discharged to both sides through the two compression sections, so that it is possible to achieve a higher compression and more stable efficiency than those of a conventional linear compressor.

### CROSS-REFERENCE TO RELATED PATENT APPLICATION

This application is a continuation of international application PCT/KR2023/000470, filed on Jan. 11, 2023, which claims the benefit of Korean Patent Application No. 10-2022-0007555, filed on Jan. 19, 2022, in the Korean Intellectual Property Office, the disclosures of which are incorporated herein in its entirety by reference.

### TECHNICAL FIELD

The present invention relates to a cylinder device for a linear compressor installed with a linear piston, and more specifically, to a cylinder device for a linear compressor installed with a linear piston in which a linear piston has compression sections formed at both ends centered on a driving section, the compression section having a larger circumference than that of the driving section, a Teflon material is applied to an outer surface of the compression section to act as a friction lubricant between the outer surface and an inner periphery of a piston hole, and a refrigerant can be sucked or discharged to both sides through the two compression sections, so that it is possible to achieve a higher compression and more stable efficiency than those of a conventional linear compressor.

### BACKGROUND

A cooling system is a system that generates cold air by circulating refrigerant, and repeats compression, condensation, expansion, and evaporation processes of the refrigerant. To this end, the cooling system includes a compressor, a condenser, an expansion device, and an evaporator. In addition, the cooling system may be installed in a refrigerator or air conditioner as a home appliance.

Generally, a compressor is a mechanical device that receives power from a power generation device such as an electric motor or turbine to compress air, refrigerant, or other various working gases to increase pressure, and is widely used in home appliances or throughout the industry.

These compressors may be broadly classified into a reciprocating compressor in which a compression space is formed between a piston and a cylinder in which the working gas is sucked and discharged, and the piston moves back and forth linearly inside the cylinder to compress the refrigerant, a rotary compressor in which a compression space is formed between an eccentrically rotating roller and the cylinder in which the working gas is sucked and discharged, and the roller rotates eccentrically along an inner wall of the cylinder to compress the refrigerant, and a scroll compressor in which a compression space is formed between an orbiting scroll and a fixed scroll in which the working gas is sucked and discharged, and the orbiting scroll rotates along the fixed scroll to compress the refrigerant.

Recently, linear compressors that can improve compression efficiency without mechanical loss due to motion conversion and have a simple structure by directly connecting the piston to a driving motor that performs reciprocating linear motion among the reciprocating compressors have been developed.

Usually, linear compressors are configured so that the piston moves in a reciprocating linear motion inside the cylinder by a linear motor inside a sealed shell, thereby sucking, compressing, and then discharging the refrigerant.

The linear motor is configured so that a permanent magnet is positioned between an inner stator and an outer stator, and the permanent magnet is driven to perform linear reciprocating motion by mutual electromagnetic force between the permanent magnet and the inner (or outer) stator. In addition, since the permanent magnet is driven in a state of being connected to the piston, the refrigerant is sucked, compressed, and then discharged while the piston performs linear reciprocating motion inside the cylinder.

However, the conventional linear compressor such as the Korean Patent Publication No. 10-2225071 has a problem in that the compression efficiency is low because the linear compressor is driven by using only one piston in one cylinder.

### SUMMARY

The present invention has been devised to solve the conventional problems.

An object of the present invention is to provide a cylinder device for a linear compressor installed with a linear piston, including: a cylinder body formed in a honeycomb shape, in which a suction hole for sucking refrigerant is formed in a center of the cylinder body, multiple piston holes are formed radially centered on the suction hole, and a connecting hole connecting the suction hole and the piston hole is formed; and a linear piston formed in each of the multiple piston holes to suck or discharge refrigerant by reciprocating in an axial direction of the piston hole, so that compression efficiency is improved without mechanical loss, and multiple linear pistons are operated sequentially, resulting in higher compression efficiency than a conventional linear compressor operated by a single piston.

Moreover, an object of the present invention is to provide a cylinder device for a linear compressor installed with a linear piston, in which a linear piston has compression sections formed at both ends centered on a driving section, the compression section having a larger circumference than that of the driving section, a Teflon material is applied to an outer surface of the compression section to act as a friction lubricant between the outer surface and an inner periphery of a piston hole, and a refrigerant can be sucked or discharged to both sides through the two compression sections, so that it is possible to achieve a higher compression and more stable efficiency than those of a conventional linear compressor.

In order to achieve the objects, according to the present invention, there is provided a cylinder device for a linear compressor installed with a linear piston, the cylinder device including: a cylinder body formed in a honeycomb shape, in which a suction hole for sucking refrigerant is formed in a center of the cylinder body, multiple piston holes are formed radially centered on the suction hole, and a connecting hole connecting the suction hole and the piston hole is formed;

an linear piston installed in each of the piston holes of the cylinder body to suck or discharge refrigerant by reciprocating in an axial direction of the piston hole; and

a discharge opening/closing valve formed on a discharge side of the piston hole to block the discharge side of the piston hole when the refrigerant is sucked by the linear piston and open the discharge side of the piston hole when the refrigerant is discharged by the linear piston.

Moreover, in the cylinder device for a linear compressor installed with a linear piston, the linear piston of the present invention may include a compression section formed on both sides to suck or discharge a refrigerant in a cylindrical shape having the same circumference as the inner periphery of the piston hole, and

a driving section formed smaller than the circumference of the compression section to be connected between the compression sections on both sides and operated by a reciprocating linear motion by an electromagnetic field of the coil to operate the compression section.

In the cylinder device for a linear compressor installed with a linear piston, a magnetic magnet may further be formed on an outer periphery of the driving section to be operated in a reciprocating linear motion by the electromagnetic field generated and transmitted from the coil.

In the cylinder device for a linear compressor installed with a linear piston, multiple magnetic magnets may be formed with N and S poles intersecting in a longitudinal direction of the driving section.

In the cylinder device for a linear compressor installed with a linear piston, a Teflon material may be applied to an outer surface of the compression section for friction lubrication with the inner periphery of the piston hole.

### BRIEF DESCRIPTION OF THE DRAWINGS

FIG. 1 is an exploded perspective view illustrating a cross-section of a cylinder device according to one embodiment of the present invention.

FIG. 2 is a cross-sectional view illustrating the cylinder device according to one embodiment of the present invention.

FIG. 3 is a plan view illustrating a cylinder body according to one embodiment of the present invention.

FIG. 4 is a front view illustrating a linear piston according to one embodiment of the present invention.

FIG. 5 is a schematic diagram illustrating the operation of the cylinder device according to one embodiment of the present invention.

### DETAILED DESCRIPTION OF EMBODIMENTS

The present invention having such features can be explained more clearly through the preferred embodiments thereof.

Before describing various embodiments of the present invention in detail with reference to the attached drawings, it should be understood that the application thereof is not limited to the details of the configuration and arrangement of the components described in the following detailed description or illustrated in the drawings. The present invention can be implemented and practiced in other embodiments and carried out in various ways. Moreover, it will be appreciated that expressions and terms used herein with respect to device or element orientation (for example, “front”, “back”, “up”, “down”, “top”, “bottom”, “left”, “right”, and “lateral”), and the like are used merely to simplify the description of the invention and do not imply or suggest that the relevant device or element simply has a particular orientation. Moreover, terms such as “first” and “second” are used herein and in the appended claims for purposes of description and are not intended to imply or suggest relative importance or intent.

Therefore, it should be understood that the embodiments described in this specification and the configurations illustrated in the drawings are merely the most preferred embodiments of the invention and do not represent all of the technical ideas of the invention, and that various equivalents and modifications may be substituted for them at the time of filing this application.

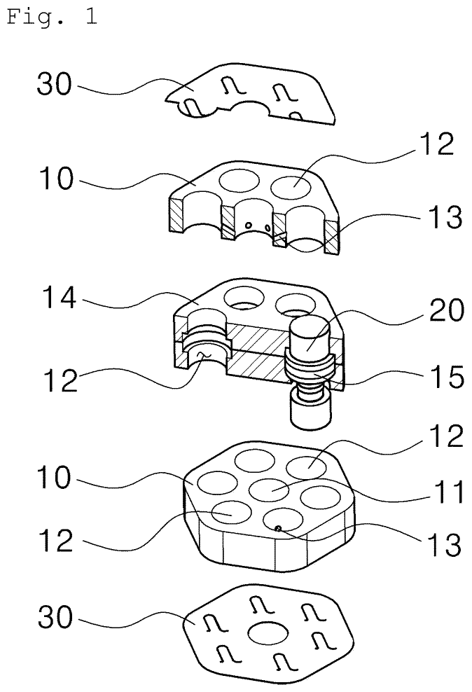

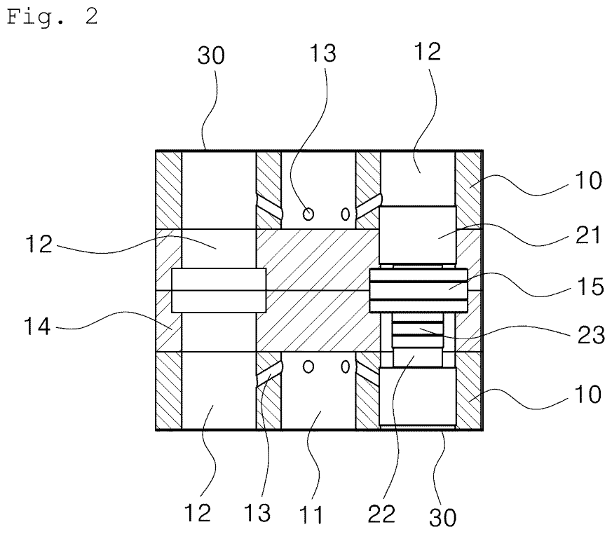

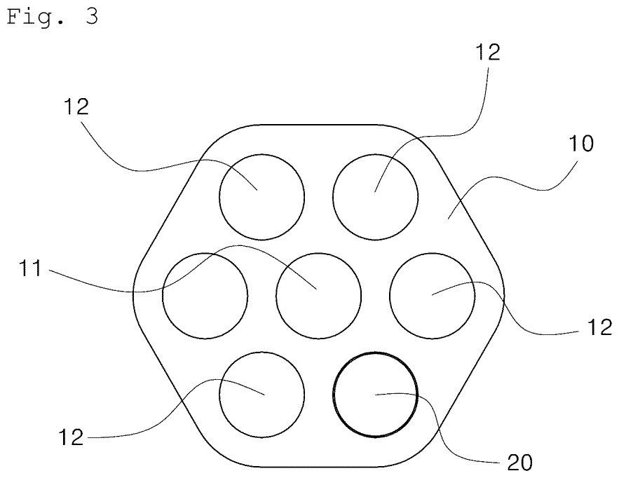

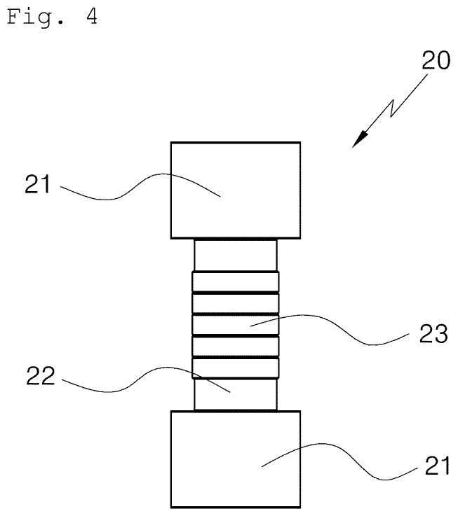

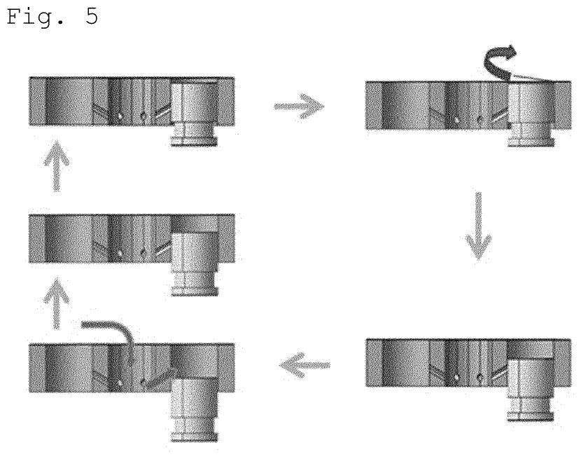

FIG. 1 is an exploded perspective view illustrating a cross-section of a cylinder device according to one embodiment of the present invention, FIG. 2 is a cross-sectional view illustrating the cylinder device according to one embodiment of the present invention, FIG. 3 is a plan view illustrating a cylinder body according to one embodiment of the present invention, FIG. 4 is a front view illustrating a linear piston according to one embodiment of the present invention, and FIG. 5 is a schematic diagram illustrating the operation of the cylinder device according to one embodiment of the present invention.

As illustrated in FIGS. 1 to 5, the cylinder device for a linear compressor installed with a linear piston of the present invention is a cylinder device installed in a linear compressor, and includes a cylinder body 10, a linear piston 20, and a discharge opening/closing valve 30.

As illustrated in FIGS. 1 to 5, the cylinder body 10 is formed in a honeycomb shape, that is, in a hexagonal shape, and a suction hole 11 through which refrigerant is sucked is formed in the center of the cylinder body 10.

Here, multiple piston holes 12 are formed radially centered on the suction hole 11 formed in the center of the cylinder body 10. In this case, the suction hole 11 and piston hole 12 are formed to penetrate both side surfaces (corresponding to the upper and lower sides in the drawing) of the cylinder body 10.

Moreover, a partition wall of the cylinder body 10 is formed between the suction hole 11 and the piston hole 12, and a connecting hole 13 connecting the suction hole 11 and the piston hole 12 is formed through the partition wall, and the connecting hole 13 is formed at a low position on the suction hole 11 side and at a high position on the piston hole 12 side, so that the connecting hole is formed to be inclined.

In addition, the suction hole 11 of the cylinder body 10 is formed at an angle of 15 to 45 degrees with respect to a vertical standard of the cylinder body 10, so that it is easy to manufacture and process the suction hole.

Meanwhile, as illustrated in FIG. 2, the cylinder body 10 includes two cylinder bodies 10 symmetrically formed above and below according to the structure of the linear piston 20, and a coil body 14 in which a coil 15 is installed is further formed between the two cylinder bodies 10.

Here, the coil body 14 is connected between the two cylinder bodies 10, and a piston hole 12 is formed at the same position in accordance with the multiple piston holes 12 formed in the cylinder body 10, but the suction hole 11 formed in the cylinder body 10 is blocked, thereby blocking the suction holes 11 of the two cylinder bodies 10 from communicating with each other. In this case, by blocking the mutual communication of the suction holes 11 of the two cylinder bodies 10 by the coil body 14, the two cylinder bodies 10 each perform their roles, thereby increasing the compression efficiency.

Moreover, a ring-shaped coil 15 is further formed in the center of the inner periphery of the piston hole 12 of the coil body 14, and the driving section 22 of the linear piston 20 is positioned in the center of the ring-shaped coil 15, so that the driving section 22 of the linear piston 20 is subjected to a reciprocating linear motion up and down by the electromagnetic field of the coil 15. At this time, the coil 15 is connected to external electricity to supply power, and the inner periphery of the central hole of the coil 15 is identical to the circumference of the magnetic magnet 23 formed in the driving section 22 of the linear piston 20, so that they are in close contact with each other.

As illustrated in FIGS. 1 to 5, the linear piston 20 includes compression sections 21 which are each inserted into the multiple piston holes 12 formed in the cylinder body 10 to perform the reciprocating linear motion in the axial direction of the piston hole 12 and formed on both sides to suck or discharge refrigerant in a cylindrical shape having the same circumference as the inner periphery of the piston hole 12, and a driving section 22 formed smaller than the circumference of the compression section 21 to be connected between the compression sections 21 on both sides and operated by a reciprocating linear motion by an electromagnetic field of the coil 15 to operate the compression section 21. In this case, the compression section 21 and the driving section 22 are screw-coupled to each other.

Here, a Teflon material is applied to the outer surface of the compression section 21 for friction lubrication with the inner periphery of the piston hole 12 to reduce friction with the inner periphery of the piston hole 12 and operate smoothly. In this case, any material that reduces friction without being affected by a refrigerant, other than Teflon, may be used as the material applied to the outer surface of the compression section 21.

In addition, a magnetic magnet 23 is further formed on an outer periphery of the driving section 22 to be operated in a reciprocating linear motion by the electromagnetic field generated and transmitted from the coil 15 of the coil body 14, and multiple magnetic magnets 23 are formed with N and S poles intersecting in a longitudinal direction of the driving section 22.

Here, the magnetic magnet 23 formed in the driving section 22 is formed in a cylindrical shape, and the outer periphery of the magnetic magnet 23 is formed smaller than the outer periphery of the compression section 21 so that the magnetic magnet operates up and down in the center of the coil 15, and the compression section 21 is configured not to be inserted into the center of the coil 15 since the compression section has a larger circumference than that of the magnetic magnet 23.

In addition, when the linear piston 20 moves linearly to one side, the refrigerant is drawn in from the outside through the suction hole 11 and then sucked into the piston hole 12 through the connecting hole 13, and when the linear piston 20 moves linearly to the other side, the refrigerant is discharged to the outside of the piston hole 12. In this case, the refrigerant is discharged through both ends of the piston hole 12.

In addition, the linear piston 20 is formed in multiple numbers to fit multiple piston holes 12, and the multiple linear pistons 20 can be sequentially operated one by one to continuously suck/discharge the refrigerant.

As illustrated in FIGS. 1 to 2 and FIG. 5, the discharge opening/closing valve 30 is formed on the discharge side of the piston hole 12, and in the present invention, the discharge opening/closing valve 30 is formed at each of both ends of the cylinder body 10. Therefore, the discharge opening/closing valve blocks the discharge side of the piston hole 12 when the refrigerant is sucked in by the linear piston 20 and opens the discharge side of the piston hole 12 when the refrigerant is discharged by the linear piston 20.

Here, the discharge opening/closing valve 30 is formed as a plate spring valve and opens and closes the discharge side of the piston hole 12 by the operation of the linear piston 20, and multiple opening/closing portions are formed according to the multiple piston holes 12.

Meanwhile, in the present invention, the discharge opening/closing valve 30 that opens and closes the discharge of the refrigerant is formed, but the valve that opens and closes the suction of the refrigerant is not separately configured. Therefore, the suction of the refrigerant is performed quickly and smoothly, and in the present invention, instead of a separate suction opening/closing valve, the suction hole 11 and the connecting hole 13 are formed, and since the connecting hole 13 can be automatically opened and closed by the operation of the linear piston 20, fast and smooth refrigerant suction is possible.

Meanwhile, a cover section (not illustrated) is further installed at both ends of the cylinder body 10 on which the discharge opening/closing valve 30 is formed at both ends, and the cover section has an intake port (not illustrated) through which refrigerant is introduced from the outside and a discharge port (not illustrated) through which refrigerant is discharged by a piston.

Here, a coil (not illustrated) that operates the linear piston 20 in which a magnet is formed is formed inside the cover section, and the coil is formed according to each of the multiple linear pistons 20, so that multiple linear pistons 20 can operate sequentially.

As described above, the cylinder device for a linear compressor installed with a linear piston of the present invention includes a cylinder body formed in a honeycomb shape, in which a suction hole for sucking refrigerant is formed in a center of the cylinder body, multiple piston holes are formed radially centered on the suction hole, a connecting hole connecting the suction hole and the piston hole is formed, and a linear piston is formed in each of the multiple piston holes to suck or discharge refrigerant by reciprocating linear motion in an axial direction of the piston hole. Accordingly, compression efficiency is improved without mechanical loss, and multiple linear pistons are operated sequentially, resulting in higher compression efficiency than a conventional linear compressor operated by a single piston.

Moreover, the linear piston has the compression sections formed at both ends centered on the driving section, the compression section having a larger circumference than that of the driving section, a Teflon material is applied to an outer surface of the compression section to act as a friction lubricant between the outer surface and the inner periphery of the piston hole, and the refrigerant can be sucked or discharged to both sides through the two compression sections. Therefore, it is possible to achieve a higher compression and more stable efficiency than those of a conventional linear compressor.

What is claimed is:

1. A cylinder device for a linear compressor installed with a linear piston, the cylinder device comprising:
a cylinder body formed in a honeycomb shape, in which a suction hole for sucking refrigerant is formed in a center of the cylinder body, multiple piston holes are formed radially centered on the suction hole, a connecting hole connecting the suction hole and the piston hole is formed, and a ring-shaped coil is formed on an inner periphery of the piston hole;
a linear piston installed in each of the piston holes of the cylinder body to suck or discharge refrigerant by reciprocating in an axial direction of the piston hole; and
a discharge opening/closing valve formed on a discharge side of the piston hole to block the discharge side of the piston hole when the refrigerant is sucked by the linear piston and open the discharge side of the piston hole when the refrigerant is discharged by the linear piston.

2. The cylinder device of claim 1, wherein the linear piston includes:
a compression section formed on both sides to suck or discharge a refrigerant in a cylindrical shape having the same circumference as the inner periphery of the piston hole, and
a driving section formed smaller than the circumference of the compression section to be connected between the compression sections on both sides and operated by a reciprocating linear motion by an electromagnetic field of the coil to operate the compression section.

3. The cylinder device of claim 2, wherein a magnetic magnet is further formed on an outer periphery of the driving section to be operated in a reciprocating linear motion by the electromagnetic field generated and transmitted from the coil.

4. The cylinder device of claim 3, wherein multiple magnetic magnets are formed with N and S poles intersecting in a longitudinal direction of the driving section.

5. The cylinder device of claim 2, wherein a Teflon material is applied to an outer surface of the compression section for friction lubrication with the inner periphery of the piston hole.
